(19) United States
(12) Patent Application Publication
(10) Pub. No.: US 2012/0045131 A1
(43) Pub. Date: Feb. 23, 2012

(54) Method of and apparatus for processing images

(75) Inventors: Yuan He, Beijing (CN); Jun Sun, Beijing (CN); Hao Yu, Beijing (CN); Satoshi Naoi, Beijing (CN); Yoshinobu Hotta, Kawasaki (JP)

(73) Assignee: Fujitsu Limited, Kawasaki (JP)

(21) Appl. No.: 13/067,389

(22) Filed: May 27, 2011

(30) Foreign Application Priority Data
Aug. 17, 2010 (CN) 201010257664.8

(51) Int. Cl. G06K 9/46

(52) U.S. Cl. 382/190

(57) ABSTRACT

Ruled lines are extracted and fitted into a real 2-D space. Correspondence between fitted cells and template cells of a ruled line template is determined. For each pair of cells corresponding to each other, the position of each pixel in the template cell is mapped into a real position in the real 2-D space based on an affine transformation between the cells. A pixel value based on pixel values of a plurality of pixels in the image with positions adjacent to the real position is generated as a pixel value of the pixel in the template cell corresponding to the real position. A synthesized image corresponding to the image is generated by merging the ruled lines of the ruled line template with the pixels in the template cells having the pixel values as generated. A form template is obtained based on the synthesized images corresponding to the plurality of images.

### CROSS-REFERENCE TO RELATED APPLICATION

This application is based on and claims the benefit of priority of the prior Chinese Patent Application No. 201010257664.8 filed on Aug. 17, 2010, the entire contents of which are incorporated herein by reference.

### FIELD

The present invention relating to an image processing technique.

### BACKGROUND

In many document imaging system, a large amount of forms are scanned into a computer system and the computer system handling the obtained document images to extract relevant information. Generally, a form includes pre-printed ruled lines and constant contents such as texts, symbols and the like. Variable contents may be filled in cells enclosed by the ruled lines through manual writing or machine printing. To extract the written or printed information, the computer system first recognizes the ruled lines and the constant contents as a form template. According to the form template, it is possible recognize regions of cells in document images and to remove portions of ruled lines and constant contents to obtain portions of variable contents as filled, and then to recognize the contents filled through manual writing or machine printing.

To recognize the form template and assign the contents as written or printed to respective cells, it is a usual technique to register document images with the form template. In the automatic form processing method, the computer system has to maintain form templates for all kinds of forms to be processed, in which ruled lines, positions of cells and constant contents in the forms are defined. The form templates may be predefined by operators through manual inputs for example, or may be generated automatically according to input document images, for example, through a method of generating form templates automatically as disclosed in U.S. Pat. No. 6,886,136.

### SUMMARY

An embodiment of the present invention is an apparatus for processing images. The apparatus may include a ruled line extracting device, a correspondence determining device, a position mapping device, a pixel value generating device, an image generating device and a form template generating device. The ruled line extracting device may extract ruled lines from each of a plurality of images and fit the extracted ruled lines into a real two dimensional space. The correspondence determining device may determine correspondence between fitted cells enclosed by the fitted ruled lines and template cells of a ruled line template by aligning the extracted ruled lines for each of the images with the ruled line template. The position mapping device may, with respect to each pair of cells which correspond to each other, map the position of each of pixels in the template cell into a real position in the real two dimensional space based on an affine transformation between the pair of cells. The pixel value generating device may generate a pixel value based on pixel values of a plurality of pixels in the image with positions adjacent to the real position, as a pixel value of the pixel in the template cell corresponding to the real position. The image generating device may generate a synthesized image corresponding to the image by merging the ruled lines of the ruled line template with the pixels in the template cells having the pixel values as generated. The form template generating device may obtain a form template based on the synthesized images corresponding to the plurality of images.

An embodiment of the present invention is a method of processing images. According to the method, it is possible to extract ruled lines from each of a plurality of images and fit the extracted ruled lines into a real two dimensional space. Correspondence between fitted cells enclosed by the fitted ruled lines and template cells of a ruled line template is determined by aligning the extracted ruled lines for each of the images with the ruled line template. With respect to each pair of cells which correspond to each other, the position of each of pixels in the template cell is mapped into a real position in the real two dimensional space based on an affine transformation between the pair of cells. A pixel value based on pixel values of a plurality of pixels in the image with positions adjacent to the real position is generated as a pixel value of the pixel in the template cell corresponding to the real position. A synthesized image corresponding to the image is generated by merging the ruled lines of the ruled line template with the pixels in the template cells having the pixel values as generated. A form template is obtained based on the synthesized images corresponding to the plurality of images.

### BRIEF DESCRIPTION OF DRAWINGS

The above and/or other aspects, features and/or advantages of the present invention will be easily appreciated in view of the following description by referring to the accompanying figures. In the accompanying drawings, identical or corresponding technical features or components will be represented with identical or corresponding reference numbers.

FIG. 1 is a block diagram illustrating an exemplary structure of an apparatus for processing images according to an embodiment of the present invention.

FIG. 2 is a diagram illustrating an example of a document image including a form.

FIG. 3 is a diagram illustrating an example of ruled line templates.

FIG. 4 is a diagram illustrating an example of fitted ruled lines and a fitted cell enclosed by the ruled lines in a real two dimensional space.

FIG. 5 is a schematic diagram illustrating an affine transformation between a template cell and a fitted cell.

FIG. 6 is a schematic diagram illustrating a map from the position of a pixel in a template cell to a real position in a real two dimensional space according to the affine transformation.

FIG. 7 is a schematic diagram illustrating a map from the position of a pixel in a template cell to a real position in a real two dimensional space according to the affine transformation between parallel planes.

FIG. 8 is a schematic diagram illustrating a relation between a real position and a position of the pixel adjacent to the real position.

FIG. 9 is a flow chart illustrating an exemplary process of a method of processing images according to an embodiment of the present invention.

FIG. 10 is a block diagram illustrating an exemplary structure of a section for generating a ruled line template according to an embodiment of the present invention.

FIG. 11 is a schematic diagram illustrating an exemplary process of generating a ruled line template according to an embodiment of the present invention.

FIG. 12 is a block diagram illustrating an exemplary structure of a computer for implementing the apparatus and the method of the present invention.

### DESCRIPTION OF EMBODIMENTS

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Aspects of the present invention are described below with reference to flowchart illustrations and/or block diagrams of methods and apparatus according to embodiments of the invention. It is to be noted that, for purpose of clarity, representations and descriptions about those components and processes known by those skilled in the art but unrelated to the present invention are omitted in the drawings and the description. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer or other programmable data processing apparatus to function in a particular manner, such that the instructions stored in the computer readable medium produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

It should be noted that the flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In a method of the prior art, a form template is extracted by aligning document images containing the same form with each other and extract a relatively constant portion therefrom. In the process of obtaining the document images, however, the forms in the document images may be deformed and distorted, especially be locally deformed and distorted to different extents, due to tilting, rotating or the like of the documents. Although it is possible to partially overcome the influence of integral rotation of the documents by alignment, it is not capable of overcome the influence of local distortion and local deformation in the documents.

Especially, cells in a form may include constant contents such as texts, symbols and the like. The local deformation and distortion to different extents in the document images may disable the ability of recognizing such constant contents into the form template, so that the constant contents are recognized as variable contents in processing the document images.

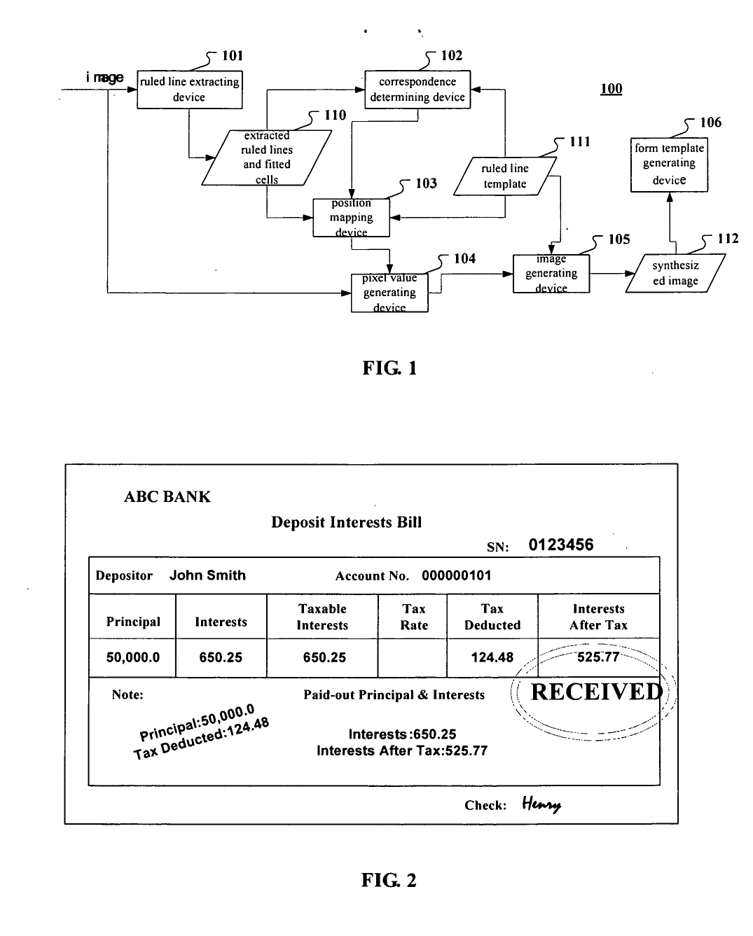

FIG. 1 is a block diagram illustrating an exemplary structure of an apparatus 100 for processing images according to an embodiment of the present invention.

As shown in FIG. 1, the apparatus 1001 includes a ruled line extracting device 101, a correspondence determining device 102, a position mapping device 103, a pixel value generating device 104, an image generating device 105 and a form template generating device 106.

The ruled line extracting device 101 extracts ruled lines from each of a plurality of images and fits the extracted ruled lines into a real two dimensional space.

Each of the plurality of images is a document image containing the same form. FIG. 2 is a diagram illustrating an example of a document image including a form. As shown in FIG. 2, respective cells are enclosed by ruled lines. Light texts included in cells are portions of constant contents, and dark texts included in cells are portions of variable contents, manually written or machine printed. Alternatively, it is also possible to assume edges of the document images as default ruled lines, and in this case, it is possible to obtain cells in edge portions of the document images by extending non-default ruled lines and default ruled lines to intersect.

It is possible to extract ruled lines from document images through known methods. For example, it is possible to adopt methods described in U.S. Pat. No. 7,039,235 and United States Patent application US2005031208. Further, it is possible to adopt a linear fitting method such as the least squares method to fit extracted ruled lines into a real two dimensional space. Here, a point on the extracted ruled lines corresponds to a pixel in a document image, with its position as an integer ordinate and an integer abscissa. A ruled line being fitted into the real two dimensional space is described with a respective function, and positions of point thereon are not limited to discrete integer values, but can be real values. FIG. 4 is a diagram illustrating an example of fitted ruled lines and a fitted cell enclosed by the ruled lines in a real two dimensional space. As shown in FIG. 4, a coordinates value (x, y) on X-axis and Y-axis represents the position of a point in the real two dimensional space. Lines 401, 402, 403 and 404 are respectively lines in the real two dimensional space obtained by fitting the extracted ruled lines. As shown in FIG. 4, these lines enclose one cell.

Through the processing by the ruled line extracting device 101, it is possible to obtain extracted ruled lines and fitted cells 110 enclosed by fitted ruled lines.

Returning to FIG. 1, the correspondence determining device 102 determines correspondence between the fitted cells 110 enclosed by the fitted ruled lines and template cells of a ruled line template 111 by aligning the extracted ruled lines 110 for each of the images with the ruled line template 111.

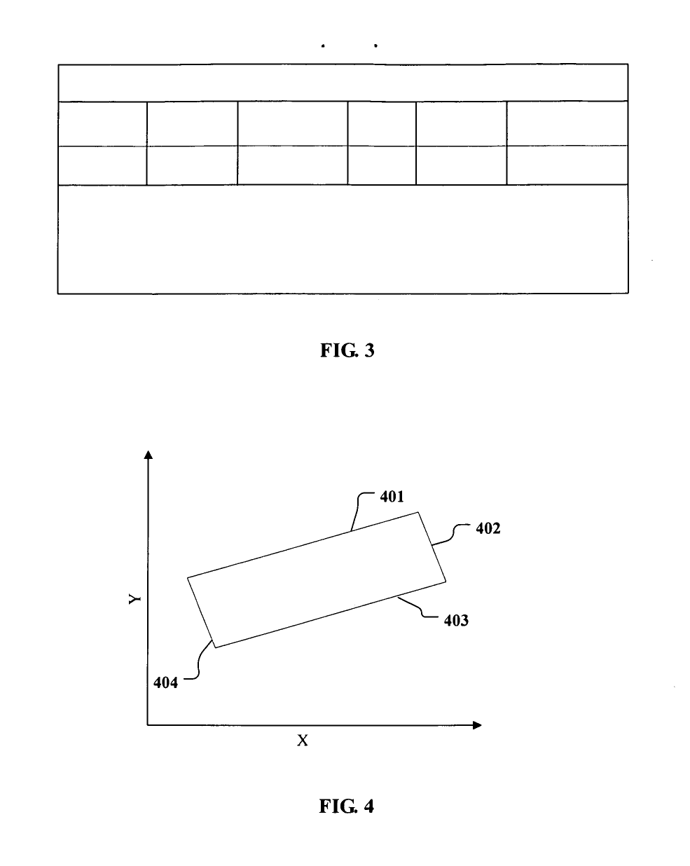

FIG. 3 is a diagram illustrating an example of ruled line templates. As shown in FIG. 3, the ruled line template includes ruled lines and cells enclosed by the ruled lines. It is possible to form the ruled line template by extracting ruled lines from randomly selected one or specified one of a plurality of images.

It is possible to adopt a known method to align extracted ruled lines from each of the images with the ruled line template. For example, it is possible to continuously shift the extracted ruled lines relative to the ruled line template and calculate a similarity between the ruled line template and the extracted ruled lines. If the maximum similarity is obtained under a relative position relation between the ruled line template and the extracted ruled lines, it is determined that, under this relative position relation, the ruled line template is aligned with the extracted ruled lines.

In case of alignment with each other, it is able to determine the correspondence between template cells in the ruled line template and cells enclosed by the extracted ruled lines. Because the correspondence between the cells enclosed by the extracted ruled lines and the fitted cells, it is able to determine the correspondence between the template cells in the ruled line template and the fitted cells.

Returning to FIG. 1, with respect to each pair of cells which correspond to each other (a template cell in the ruled line template and a fitted cell in the real two dimensional space), the position mapping device 103 maps the position of each of pixels in the template cell into a real position in the real two dimensional space based on an affine transformation between the pair of cells.

FIG. 5 is a schematic diagram illustrating an affine transformation between a template cell and a fitted cell.

The affine transformation is a kind of transformations from an affine plane (or space) to itself. Properties of the affine transformation includes colinear property of points (or coplanar property) and constant simple ratio property of three colinear points. As shown in FIG. 5, a cell ABCD in a plane 501 is a template cell, and a cell A′B′C′D′ in a plane 502 is a fitted cell obtained by performing the affine transformation on the cell ABCD.

According to the colinear property, of points, since points A, E and B in the plane 501 are colinear and points D, F and C in the plane 501 are colinear, corresponding points A′, E′ and B′ obtained by performing the affine transformation on points A, E and B are colinear, and corresponding points D′, F′ and C′ obtained by performing the affine transformation on points D, F and C are colinear. According to the constant simple ratio property of three colinear points, Len(A,E)/Len(E,B)=Len(A′,E′)/Len(E′,B′), Len(D,F)/Len(F,C)=Len(D′,F′)/Len(F′,C′), wherein Len(,) represents a distance between two points.

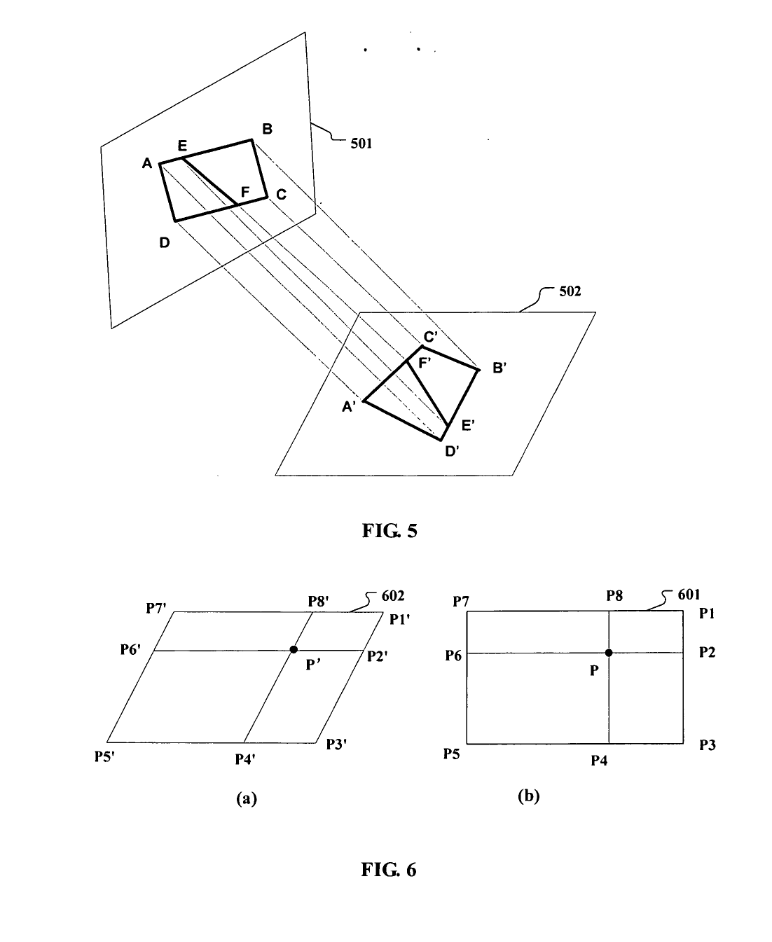

Assuming that an affine transformation relation exists between a template cell and a fitted cell corresponding to each other, it is possible determine the point in the fitted cell to which any pixel in the template cell is mapped by using the above property. Such a mapping method will be described later by taking the scenario shown in FIG. 6 as an example.

FIG. 6 is a schematic diagram illustrating a map from positions of pixels in a template cell to real positions in the real two dimensional space according to an affine transformation, wherein FIG. 6(b) shows a template cell 601 (with vertex points P1, P3, P5 and P7), FIG. 6(a) shows a fitted cell 602 (with vertex points P1′, P3′, P5′ and P7′) corresponding to the template cell 601. For any point P in the template cell 601, it is possible to view it as an intersection of two lines, wherein one line intersects with the ruled lines at points P4 and P8, and another line intersects with the ruled lines at points P2 and P6. Assume that the vertex points P1′, P3′, P5′ and P7′ correspond to the vertex points P1, P3, P5 and P7 respectively, according to the colinear property and the constant simple ratio property, it is possible to determine points P2′, P4′, P6′ and P8′ in the fitted cell 602, which correspond to the points P2, P4, P6 and P8 respectively. According to the colinear property again, it is possible to determine an intersection P′ between a line P2′P6′ and a line P4′P8′, i.e., a point corresponding to the point P. The position of the intersection P′ is the real position P′ in the real two dimensional space to which the position P of the pixel in the template cell is mapped.

In an alternative embodiment, the affine transformation may be simplified to that between parallel planes. In this case, it is possible to regard the fitted cell as obtained through rotating the corresponding template cell. In the embodiment, it is possible to calculate the rotating angel of the fitted cell relative to the template cell, and to calculate the position of a point in the fitted cell corresponding to any point in the template cell according to the rotating angel.

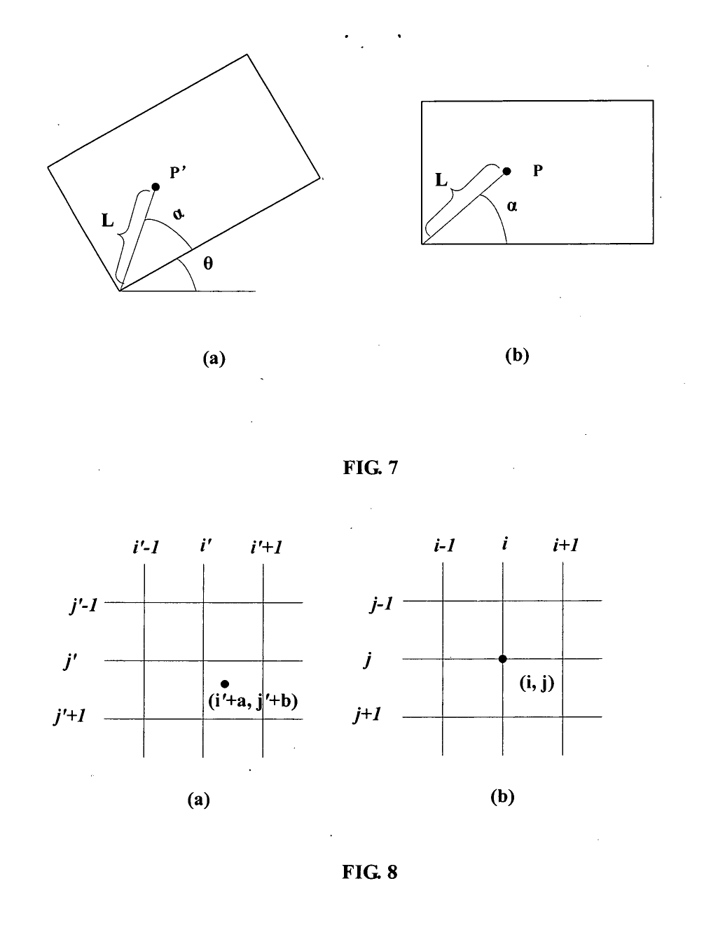

FIG. 7 is a schematic diagram illustrating a map from the position of a pixel in a template cell to a real position in a real two dimensional space according to the affine transformation between parallel planes, wherein FIG. 7(b) shows a template cell, and FIG. 7(a) shows a fitted cell corresponding to the template cell. For any point P in the template cell, it is possible to calculate an angle α between one of X-axis and Y-axis (in the example of FIG. 7, it is the bottom side of the template cell, and in the same direction with X-axis) and a connected line for connecting the point P and a reference point in the template cell. The reference point may be any point in the plane where the template cell or even the template cell is located, as long as it is able to determine a mapped reference point in the plane where the fitted cell is located, corresponding to the reference point. Preferably, the reference point may be a point which facilitates the determination of the mapped reference point, such as a vertex point of the template cell. With respect to the fitted cell, an angle θ between the above one of X-axis and Y-axis and a side in the fitted cell corresponding to the above bottom side of the template cell is calculated, thereby obtaining an angle α+θ between the above one of X-axis and Y-axis and a line in the fitted cell corresponding to the above connected line. Because the above connected line and the line corresponding to the above connected line have the same length, in case of knowing the mapped reference point and the angle α+θ, it is able to calculate the position of the corresponding point P′ in the real two dimensional space.

Returning to FIG. 1, the pixel value generating device 104 generates a pixel value based on pixel values of a plurality of pixels in the image with positions adjacent to the real position, as a pixel value of the pixel in the template cell corresponding to the real position.

FIG. 8 is a schematic diagram illustrating a relation between a real position and a position of the pixel adjacent to the real position. FIG. 8(a) shows a real position (i′+a, j′+b), wherein i′, j′ are integer portions of the reals, and a, b are decimal portions of the reals. Positions of pixels adjacent to the real position (i′+a, j′+b) are (i′, j′), (i′+1, j′), (i′, j′), (i′+1, j′+1) respectively. It should be noted that positions of adjacent pixels are not limited to the pixel positions as described, and they may also comprise positions of other adjacent pixels. FIG. 8(b) shows a position (i, j) of the pixel in the template cell corresponding to the real position.

In one embodiment, the pixel value generating device 104 may generate the pixel value by calculating a weighted sum of pixel values of a plurality of pixels (for example, (i′, j′), (i′+1, j′), (i′, j′), (i′+1, j′+1)) in the image having positions adjacent to the real position, wherein the shorter the distance between the position of each pixel and the real position, the larger the weight of the corresponding pixel value. For example, assuming a real position of (i′+a, j′+b), the generated pixel value may be (1−a)×(1−b)×f(i′, j′)+a×(1−b)×f(i′+1, j′)+b×(1−a)×f(i′, j′+1)+a×b×f(i′+1, j′+1), wherein f(x, y) is the pixel value of a pixel (x, y) in the image.

In another embodiment, the pixel value generating device 104 may regard the minimum of pixel values of a plurality of pixels (for example, (i′, j′), (i′+1, j′), (i′, j′), (i′+1, j′+1)) in the image having positions adjacent to the real position, i.e., min{f(i′, f(i′+1, j′), f(i′, j′+1), f(i′+1, j′+1)}, as the generated pixel value, wherein f(x, y) is the pixel value of a pixel (x, y) in the image.

Returning to FIG. 1, the image generating device 105 generates a synthesized image 112 corresponding to the image by merging the ruled lines of the ruled line template with the pixels in the template cells having the generated pixel values. That is to say, the synthesized image 112 includes the ruled lines in the ruled line template and non-ruled line pixels in the template cell. For the non-ruled line pixels in the synthesized image 112, their pixel values are those obtained by the pixel value generating device 104.

The form template generating device 106 obtains the form template based on the synthesized images 112 corresponding to the plurality of images. Known methods may be adopted to obtain the form template based on the synthesized images corresponding to the plurality of images. For example, it is possible to adopt the method described in U.S. Pat. No. 6,886,136. Alternatively, the form template generating device 106 may obtain the form template through the following way: with respect to each of pixels in the form template, a maximum pixel value of corresponding pixels in the plurality of synthesized images is obtained as the pixel value of the pixel.

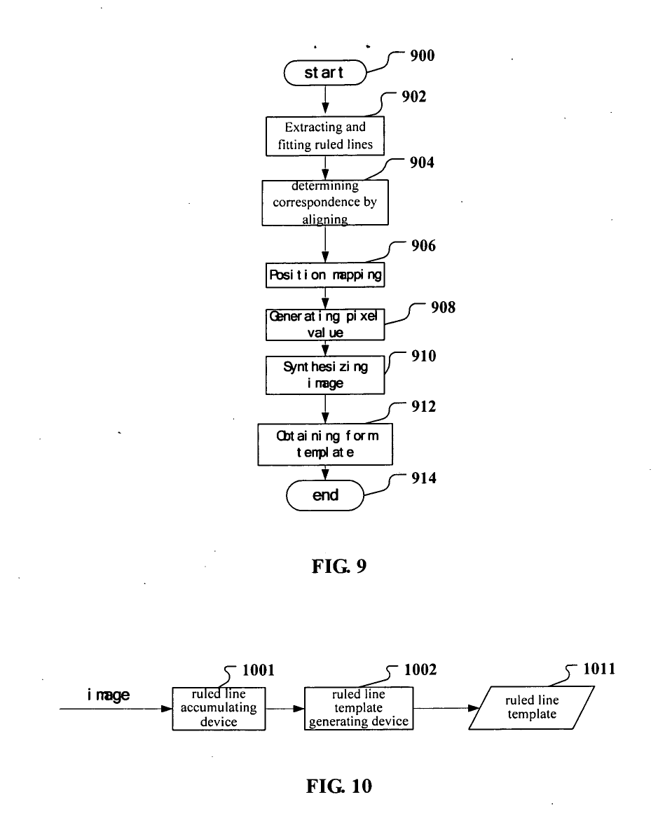

FIG. 9 is a flow chart illustrating an exemplary process of a method of processing images according to an embodiment of the present invention.

As shown in FIG. 9, the method starts from step 900. At step 902, ruled lines are extracted from each of a plurality of images and the extracted ruled lines are fitted into a real two dimensional space.

Each of the plurality of images is a document image containing the same form. Respective cells are enclosed by the ruled lines. Light texts included in cells are portions of constant contents, and dark texts included in cells are portions of variable contents, manually written or machine printed. Alternatively, it is also possible to assume edges of the document images as default ruled lines, and in this case, it is possible to obtain cells in edge portions of the document images by extending non-default ruled lines and default ruled lines to intersect.

It is possible to extract ruled lines from document images through known methods. For example, it is possible to adopt methods described in U.S. Pat. No. 7,039,235 and United States Patent application US2005031208. Further, it is possible to adopt a linear fitting method such as the least squares method to fit extracted ruled lines into a real two dimensional space. Here, a point on the extracted ruled lines corresponds to a pixel in a document image, with its position as an integer ordinate and an integer abscissa. A ruled line being fitted into the real two dimensional space is described with a respective function, and positions of point thereon are not limited to discrete integer values, but can be real values.

Through the processing of step 902, it is possible to obtain extracted ruled lines and fitted cells enclosed by fitted ruled lines.

At step 904, correspondence between fitted cells enclosed by the fitted ruled lines and template cells of a ruled line template is determined by aligning the extracted ruled lines for each of the images with the ruled line template.

It is possible to form the ruled line template by extracting ruled lines from randomly selected one or specified one of a plurality of images.

It is possible to adopt a known method to align extracted ruled lines from each of the images with the ruled line template. For example, it is possible to continuously shift the extracted ruled lines relative to the ruled line template and calculate a similarity between the ruled line template and the extracted ruled lines. If the maximum similarity is obtained under a relative position relation between the ruled line template and the extracted ruled lines, it is determined that, under this relative position relation, the ruled line template is aligned with the extracted ruled lines.

In case of alignment with each other, it is able to determine the correspondence between template cells in the ruled line template and cells enclosed by the extracted ruled lines. Because the correspondence between the cells enclosed by the extracted ruled lines and the fitted cells, it is able to determine the correspondence between the template cells in the ruled line template and the fitted cells.

At step 906, with respect to each pair of cells which correspond to each other (a template cell in the ruled line template and a fitted cell in the real two dimensional space), the position of each of pixels in the template cell is mapped into a real position in the real two dimensional space based on an affine transformation between the pair of cells.

Assuming that an affine transformation relation exists between a template cell and a fitted cell corresponding to each other, it is possible determine the point in the fitted cell to which any pixel in the template cell is mapped by using the colinear property and the constant simple ratio property.

In an alternative embodiment, the affine transformation may be simplified to that between parallel planes. In this case, it is possible to regard the fitted cell as obtained through rotating the corresponding template cell. In the embodiment, it is possible to calculate the rotating angel of the fitted cell relative to the template cell, and to calculate the position of a point in the fitted cell corresponding to any point in the template cell according to the rotating angel.

At step 908, a pixel value is generated based on pixel values of a plurality of pixels in the image with positions adjacent to the real position, as a pixel value of the pixel in the template cell corresponding to the real position.

A real position (i′+a, j′+b) is assumed, wherein i′, j′ are integer portions of the reals, and a, b are decimal portions of the reals. Positions of pixels adjacent to the real position (i′+a, j′+b) are (i′, j′), (i′+1, j′), (i′, j′), (i′+1, j′+1) respectively. It should be noted that positions of adjacent pixels are not limited to the pixel positions as described, and they may also comprise positions of other adjacent pixels. The position of a pixel in the template cell corresponding to the real position is (i, j).

In one embodiment, it is possible to generate the pixel value by calculating a weighted sum of pixel values of a plurality of pixels (for example, (i′, j′), (i′+1, j′), (i′, j′), (i′+1, j′+1)) in the image having positions adjacent to the real position, wherein the shorter the distance between the position of each pixel and the real position, the larger the weight of the corresponding pixel value. For example, assuming a real position of (i′+a, j′+b), the generated pixel value may be (1−a)×(1−b)×f(i′, j′)+a×(1−b)×f(i′+1, j′)+b×(1−a)×f(i′, j′+1)+a×b×f(i′+1, j′+1), wherein f(x, y) is the pixel value of a pixel (x, y) in the image.

In another embodiment, it is possible to regard the minimum of pixel values of a plurality of pixels (for example, (i′, j′), (i′+1, j′), (i′, j′), (i′+1, j′+1)) in the image having positions adjacent to the real position, i.e., min{f(i′, j′), f(i′+1, j′), f(i′, j′+1), f(i′+1, j′+1)}, as the generated pixel value, wherein f(x, y) is the pixel value of a pixel (x, y) in the image.

At step 910, a synthesized image 112 corresponding to the image is generated by merging the ruled lines of the ruled line template with the pixels in the template cells having the generated pixel values. That is to say, the synthesized image includes the ruled lines in the ruled line template and non-ruled line pixels in the template cell. For the non-ruled line pixels in the synthesized image, their pixel values are those obtained through step 908.

At step 912, the form template is obtained based on the synthesized images corresponding to the plurality of images. Known methods may be adopted to obtain the form template based on the synthesized images corresponding to the plurality of images. For example, it is possible to adopt the method described in U.S. Pat. No. 6,886,136. The method ends at step 914. Alternatively, at step 912, it is possible to obtain the form template through the following way: with respect to each of pixels in the form template, a maximum pixel value of corresponding pixels in the plurality of synthesized images is obtained as the pixel value of the pixel.

According to the embodiments of the present invention, because the deformation and the distortion are corrected in units of cells, it is able to eliminate the distortion in the document images more accurately, and ensure the quality of the document alignment, thereby increasing the accuracy of the form templates.

Further, it is also possible to obtain a ruled line template based on a plurality of images.

FIG. 10 is a block diagram illustrating an exemplary structure of a section for generating a ruled line template according to an embodiment of the present invention. This section may be implemented separately, or may be included in the apparatus described by referring to FIG. 1.

As shown in FIG. 10, the section for generating a ruled line template comprises a ruled line accumulating device 1001 and a ruled line template generating device 1002.

The ruled line accumulating device 1001 aligns the extracted ruled lines with each other between the plurality of images and accumulates pixel values of the pixels in the extracted ruled lines of the plurality of images on a blank image.

The ruled line template generating device 1002 generates the ruled line template by recognizing each of pixels of the blank image having an accumulated value greater than a predetermined threshold as one in the ruled lines.

FIG. 11 is a schematic diagram illustrating an exemplary process of generating a ruled line template according to an embodiment of the present invention.

As shown in FIG. 11, as a start of the process, ruled lines 1101₁, . . . , 1101ₙ are extracted from a plurality of images respectively. The extracted ruled lines 1101₁, . . . , 1101ₙ are aligned with each other between the plurality of images. At step 1102, pixel values of the pixels in the extracted ruled lines 1101₁, . . . , 1101ₙ of the plurality of images are accumulated on a blank image. At step 1103, the ruled line template 1104 is generated by recognizing each of pixels of the blank image having an accumulated value greater than a predetermined threshold as one in the ruled lines.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, microcode, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

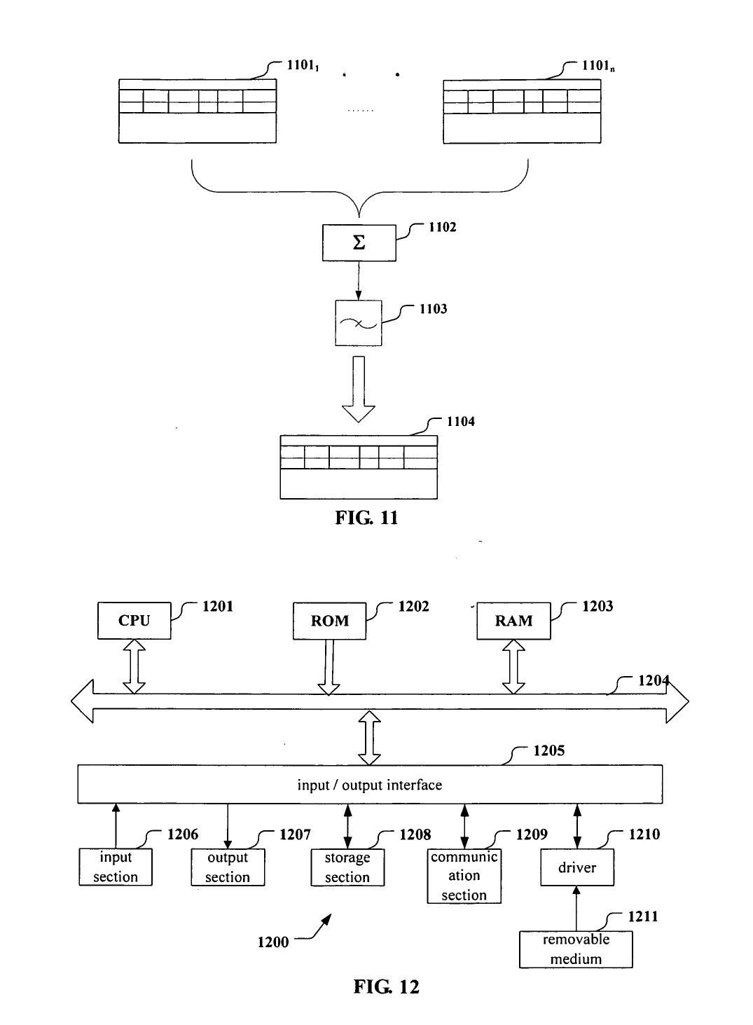

FIG. 12 is a block diagram illustrating an exemplary structure of a computer for implementing the apparatus and the method of the present invention.

In FIG. 12, a central processing unit (CPU) 1201 performs various processes in accordance with a program stored in a read only memory (ROM) 1202 or a program loaded from a storage section 1208 to a random access memory (RAM) 1203. In the RAM 1203, data required when the CPU 1201 performs the various processes or the like is also stored as required.

The CPU 1201, the ROM 1202 and the RAM 1203 are connected to one another via a bus 1204. An input/output interface 1205 is also connected to the bus 1204.

The following components are connected to the input/output interface 1205: an input section 1206 including a keyboard, a mouse, or the like; an output section 1207 including a display such as a cathode ray tube (CRT), a liquid, crystal display (LCD), or the like, and a loudspeaker or the like; the storage section 1208 including a hard disk or the like; and a communication section 1209 including a network interface card such as a LAN card, a modem, or the like. The communication section 1209 performs a communication process via the network such as the internet.

The driver 1210 is also connected to the input/output interface 1205 as required. A removable medium 1211, such as a magnetic disk, an optical disk, a magneto-optical disk, a semiconductor memory, or the like, is mounted on the drive 1210 as required, so that a computer program read therefrom is installed into the storage section 1008 as required.

In the case where the above—described steps and processes are implemented by the software, the program that constitutes the software is installed from the network such as the internet or the storage medium such as the removable medium 1211.

One skilled in the art should note that, this storage medium is not limit to the removable medium 1211 having the program stored therein as illustrated in FIG. 12, which is delivered separately from the approach for providing the program to the user. Examples of the removable medium 1211 include the magnetic disk, the optical disk (including a compact disk-read only memory (CD-ROM) and a digital versatile disk (DVD)), the magneto-optical disk (including a mini-disk (MD)), and the semiconductor memory. Alternatively, the storage medium may be the ROM 1202, the hard disk contained in the storage section 1208, or the like, which have the program stored therein and is deliver to the user together with the method that containing them.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Annex 1. An apparatus for processing images comprising:

A ruled line extracting device which extracts ruled lines from each of a plurality of images and fits the extracted ruled lines into a real two dimensional space;

a correspondence determining device which determines correspondence between fitted cells enclosed by the fitted ruled lines and template cells of a ruled line template by aligning the extracted ruled lines for each of the images with the ruled line template;

a position mapping device which, with respect to each pair of cells which correspond to each other, maps the position of each of pixels in the template cell into a real position in the real two dimensional space based on an affine transformation between the pair of cells;

a pixel value generating device which generates a pixel value based on pixel values of a plurality of pixels in the image with positions adjacent to the real position, as a pixel value of the pixel in the template cell corresponding to the real position;

an image generating device which generates a synthesized image corresponding to the image by merging the ruled lines of the ruled line template with the pixels in the template cells having the pixel values as generated; and

a form template generating device which obtains a form template based on the synthesized images corresponding to the plurality of images.

Annex 2. The apparatus according to annex 1, further comprising:

a ruled line accumulating device which aligns the extracted ruled lines with each other between the plurality of images and accumulates pixel values of the pixels in the extracted ruled lines of the plurality of images on a blank image; and

a ruled line template generating device which generates the ruled line template by recognizing a pixel of the blank image having an accumulated value greater than a predetermined threshold as one in the ruled lines.

Annex 3. The apparatus according to annex 1 or 2, wherein the affine transformation is one between parallel planes.

Annex 4. The apparatus according to annex 1 or 2, wherein assuming that the real position is (i+a, j+b), the generated pixel value=(1−a)×(1−b)×f(i, j)+a×(1−b)×f(i+1, j)+b×(1−a)×f(i, j+1)+a×b×f(i+1, j+1), wherein f(x, y) is a pixel value of the pixel (x, y) in the image.

Annex 5. The apparatus according to annex 1 or 2, wherein assuming that the real position is (i+a, j+b), the generated pixel value=min{f(i, j), f(i+1, j), f(i, j+1), f(i+1, j+1)}, wherein f(x, y) is a pixel value of the pixel (x, y) in the image.

Annex 6. The apparatus according to annex 1 or 2, wherein the form template generating device is further configured to, with respect to each of pixels in the form template, obtain a maximum pixel value of corresponding pixels in the plurality of synthesized images as that of the pixel.

Annex 7. A method of processing images comprising:

extracting ruled lines from each of a plurality of images and fitting the extracted ruled lines into a real two dimensional space;

determining correspondence between fitted cells enclosed by the fitted ruled lines and template cells of a ruled line template by aligning the extracted ruled lines for each of the images with the ruled line template;

with respect to each pair of cells which correspond to each other, mapping the position of each of pixels in the template cell into a real position in the real two dimensional space based on an affine transformation between the pair of cells;

generating a pixel value based on pixel values of a plurality of pixels in the image with positions adjacent to the real position, as a pixel value of the pixel in the template cell corresponding to the real position;

generating a synthesized image corresponding to the image by merging the ruled lines of the ruled line template with the pixels in the template cells having the pixel values as generated; and

obtaining a form template based on the synthesized images corresponding to the plurality of images.

Annex 8. The method according to annex 7, further comprising:

aligning the extracted ruled lines with each other between the plurality of images and accumulating pixel values of the pixels in the extracted ruled lines of the plurality of images on a blank image; and

generating the ruled line template by recognizing a pixel of the blank image having an accumulated value greater than a predetermined threshold as one in the ruled lines.

Annex 9. The method according to annex 7 or 8, wherein the affine transformation is one between parallel planes.

Annex 10. The method according to annex 7 or 8, wherein assuming that the real position is (i+a, j+b), the generated pixel value=(1−a)×(1−b)×f(i, j)+a×(1−b)×f(i+1, j)+b×(1−a)×f(i, j+1)+a×b×f(i+1, j+1), wherein f(x, y) is a pixel value of the pixel (x, y) in the image.

Annex 11. The method according to annex 7 or 8, wherein assuming that the real position is (i+a, j+b), the generated pixel value=min{f(i, j), f(i+1, j), f(i, j+1), f(i+1, j+1)}, wherein f(x, y) is a pixel value of the pixel (x, y) in the image.

Annex 12. The method according to annex 7 or 8, wherein generating the form template comprises, with respect to each of pixels in the form template, obtaining a maximum pixel value of corresponding pixels in the plurality of synthesized images as that of the pixel.

1. An apparatus for processing images comprising:
a ruled line extracting device which extracts ruled lines from each of a plurality of images and fits the extracted ruled lines into a real two dimensional space;
a correspondence determining device which determines correspondence between fitted cells enclosed by the fitted ruled lines and template cells of a ruled line template by aligning the extracted ruled lines for each of the images with the ruled line template;
a position mapping device which, with respect to each pair of cells which correspond to each other, maps the position of each of pixels in the template cell into a real position in the real two dimensional space based on an affine transformation between the pair of cells;
a pixel value generating device which generates a pixel value based on pixel values of a plurality of pixels in the image with positions adjacent to the real position, as a pixel value of the pixel in the template cell corresponding to the real position;
an image generating device which generates a synthesized image corresponding to the image by merging the ruled lines of the ruled line template with the pixels in the template cells having the pixel values as generated; and
a form template generating device which obtains a form template based on the synthesized images corresponding to the plurality of images.

2. The apparatus according to claim 1, further comprising:
a ruled line accumulating device which aligns the extracted ruled lines with each other between the plurality of images and accumulates pixel values of the pixels in the extracted ruled lines of the plurality of images on a blank image; and
a ruled line template generating device which generates the ruled line template by recognizing a pixel of the blank image having an accumulated value greater than a predetermined threshold as one in the ruled lines.

3. The apparatus according to claim 1, wherein assuming that the real position is (i+a, j+b), the generated pixel value=(1−a)×(1−b)×f(i, j)+a×(1−b)×f(i+1, j)+b×(1−a)×f(i, j+1)+a×b×f(i+1, j+1), wherein f(x, y) is a pixel value of the pixel (x, y) in the image.

4. The apparatus according to claim 2, wherein assuming that the real position is (i+a, j+b), the generated pixel value=(1−a)×(1−b)×f(i, j)+a×(1−b)×f(i+1, j)+b×(1−a)×f(i, j+1)+a×b×f(i+1, j+1), wherein f(x, y) is a pixel value of the pixel (x, y) in the image.

5. The apparatus according to claim 1, wherein assuming that the real position is (i+a, j+b), the generated pixel value=min{f(i, j), f(i+1, j), f(i, j+1), f(i+1, j+1)}, wherein f(x, y) is a pixel value of the pixel (x, y) in the image.

6. The apparatus according to claim 2, wherein assuming that the real position is (i+a, j+b), the generated pixel value=min{f(i, j), f(i+1, j), f(i, j+1), f(i+1, j+1)}, wherein f(x, y) is a pixel value of the pixel (x, y) in the image.

7. The apparatus according to claim 1, wherein the form template generating device is further configured to, with respect to each of pixels in the form template, obtain a maximum pixel value of corresponding pixels in the plurality of synthesized images as that of the pixel.

8. The apparatus according to claim 2, wherein the form template generating device is further configured to, with respect to each of pixels in the form template, obtain a maximum pixel value of corresponding pixels in the plurality of synthesized images as that of the pixel.

9. A method of processing images comprising:
extracting ruled lines from each of a plurality of images and fitting the extracted ruled lines into a real two dimensional space;
determining correspondence between fitted cells enclosed by the fitted ruled lines and template cells of a ruled line template by aligning the extracted ruled lines for each of the images with the ruled line template;
with respect to each pair of cells which correspond to each other, mapping the position of each of pixels in the template cell into a real position in the real two dimensional space based on an affine transformation between the pair of cells;
generating a pixel value based on pixel values of a plurality of pixels in the image with positions adjacent to the real position, as a pixel value of the pixel in the template cell corresponding to the real position;
generating a synthesized image corresponding to the image by merging the ruled lines of the ruled line template with the pixels in the template cells having the pixel values as generated; and
obtaining a form template based on the synthesized images corresponding to the plurality of images.

10. The method according to claim 9, further comprising:
aligning the extracted ruled lines with each other between the plurality of images and accumulating pixel values of the pixels in the extracted ruled lines of the plurality of images on a blank image; and
generating the ruled line template by recognizing a pixel of the blank image having an accumulated value greater than a predetermined threshold as one in the ruled lines.

11. The method according to claim 9, wherein assuming that the real position is (i+a, j+b), the generated pixel value=(1−a)×(1−b)×f(i, j)+a×(1−b)×f(i+1, j)+b×(1−a)×f(i, j+1)+a×b×f(i+1, j+1), wherein f(x, y) is a pixel value of the pixel (x, y) in the image.

12. The method according to claim 10, wherein assuming that the real position is (i+a, j+b), the generated pixel value=(1−a)×(1−b)×f(i, j)+a×(1−b)×f(i+1, j)+b×(1−a)×f(i, j+1)+a×b×f(i+1, j+1), wherein f(x, y) is a pixel value of the pixel (x, y) in the image.

13. The method according to claim 9, wherein assuming that the real position is (i+a, j+b), the generated pixel value=min{f(i, j), f(i+1, j), f(i, j+1), f(i+1, j+1)}, wherein f(x, y) is a pixel value of the pixel (x, y) in the image.

14. The method according to claim 10, wherein assuming that the real position is (i+a, j+b), the generated pixel value=min{f(i, j), f(i+1, j), f(i, j+1), f(i+1, j+1)}, wherein f(x, y) is a pixel value of the pixel (x, y) in the image.

15. The method according to claim 9, wherein generating the form template comprises, with respect to each of pixels in the form template, obtaining a maximum pixel value of corresponding pixels in the plurality of synthesized images as that of the pixel.

16. The method according to claim 10, wherein generating the form template comprises, with respect to each of pixels in the form template, obtaining a maximum pixel value of corresponding pixels in the plurality of synthesized images as that of the pixel.
